(19) United States
(12) Patent Application Publication
(10) Pub. No.: US 2026/0121500 A1
(43) Pub. Date: Apr. 30, 2026

(54) VIBRATION MOTOR

(71) Applicant: AAC Microtech (Changzhou) Co., Ltd., Changzhou City (CN)

(72) Inventors: Zhizhong She, Changzhou (CN); Junsheng Wang, Changzhou (CN)

(21) Appl. No.: 19/008,555

(22) Filed: Jan. 2, 2025

Related U.S. Application Data
(63) Continuation of application No. PCT/CN2024/113368, filed on Aug. 20, 2024.

(51) Int. Cl. H02K 33/18

(52) U.S. Cl. CPC H02K 33/18

(57) ABSTRACT

A vibration motor is provided according to the embodiments of the present disclosure, which includes a housing with an accommodating space, a vibration unit accommodated in the accommodating space, a non-metallic elastic member fixed in the housing, a driving assembly accommodated in the housing and configured to drive the vibration unit to vibrate, and the elastic member configured to elastically suspend the vibration unit in the accommodating space. The non-metallic elastic member of the vibration motor according to the present disclosure is made of a non-metallic material, which can ensure the good stability of the elastic member, so that the vibration motor can be designed thinner, the shape of the elastic part is designable, the play space for design is large, the assembly process is simple, the cost is saved, and the service life of the vibration motor is ensured.

### TECHNICAL FIELD

Embodiments of the present disclosure relate to the technical field of vibration, and in particular to a vibration motor.

### BACKGROUND

A vibration motor is a kind of machine that converts other forms of energy into mechanical vibration, which is mainly used in devices that require vibration, such as smartphones, game consoles, tablets, and VR devices with vibration sensation.

The vibration motor mainly includes a housing, a vibration unit accommodated inside the housing, an elastic member configured to elastically suspend the vibration unit inside the housing, and a driving assembly fixed inside the housing and configured to drive the vibration unit to vibrate.

The elastic members in related art mainly use metal springs or metal spring plates. In this elastic support method, which uses a metal elastic member, the amplitude of the vibration unit is easily limited by the stress of the elastic member when the vibration unit vibrates. For example, when the amplitude of the vibration unit is greater than 0.65mm and the vibration unit is in an environment of 65% relative humidity and 95 degrees Celsius, the risk of fracture failure of the elastic member increases. The metal elastic member can also limit the design thickness of the vibration motor. For example, when the thickness of the vibration motor is less than 2.4mm, the risk of fracture failure increases due to the increased stress on the elastic member. The metal elastic member can only be made by stamping, and the shape is less designable and has limited play space for design. The metal elastic member also need to be connected with the vibration unit and the housing by laser welding, which is prone to the risk of welding failure, and requires the use of welding pads to press the limit, resulting in complicated assembly process and high cost.

In summary, the use of the metal elastic member for elastic support in the vibration motor in related art is prone to the risk of failure of the elastic member, and may limit the design thickness of the vibration motor. In addition, the shape designability is low, the play space for design is small, the assembly process is complicated, and the cost is high.

Therefore, it is necessary to provide a novel vibration motor to solve the above technical problems.

### SUMMARY

An objective is to provide a novel vibration motor, so as to solve the problems that in the related art, when the vibration motor is supported by the metal elastic member, the elastic member is prone to fail, thereby resulting in the limited design thickness of the vibration motor, the low shape designability, the small play space for design, the complicated assembly process and the high cost.

A vibration motor is provided according to the embodiments of the present disclosure, which includes a housing with an accommodating space, a vibration unit accommodated in the accommodating space, a non-metallic elastic member fixed in the housing, a driving assembly accommodated in the housing and configured to drive the vibration unit to vibrate, and the elastic member configured to elastically suspend the vibration unit in the accommodating space.

In an embodiment, the non-metallic elastic member is any one of a silicone elastic member, a plastic elastic member, and a resin elastic member.

In an embodiment, two non-metallic elastic members are provided and are respectively arranged on two opposite sides of the vibration unit in a vibration direction of the vibration unit, a respective non-metallic elastic member of the two non-metallic elastic members includes a first fixing arm fixed to the housing, a second fixing arm fixed to the vibration unit, and an elastic arm connecting the first fixing arm with the second fixing arm.

In an embodiment, the vibration motor further includes two blocking sheets fixed in the housing at an interval, the two blocking sheets are respectively arranged on two opposite side of the vibration unit, a respective blocking sheet of the two blocking sheets clamps and fixes the first fixing arm to the housing, and the elastic arm passes through the respective blocking sheet.

In an embodiment, the respective blocking sheet includes a blocking sheet body spaced apart from the housing, and two connecting portions formed by bending and extending two ends of the blocking sheet body, the two connecting portions are respectively fixed on two opposite sides of the housing, and the blocking sheet body of the respective blocking sheet fixes the first fixing arm to the housing.

In an embodiment, the vibration unit further includes a mass block, the mass block includes a mass block body, extension portions formed by extending from two opposite sides of the mass block body in a direction away from the mass block body, and clamping portions formed by bending and extending from one end of each respective extension portion away from the mass block body, the clamping portions are spaced apart from the mass block body, the second fixing arm of the respective non-metallic elastic member is clamped and fixed between a respective clamping portion of the clamping portions and the mass block body, and the elastic arm passes through the respective clamping portion.

In an embodiment, a position-limiting groove is defined in the respective clamping portion and passes through the respective clamping portion, one end of the second fixing arm of the respective non-metallic elastic member close to the first fixing arm is provided with a position-limiting portion extending toward the position-limiting groove of the respective clamping portion, and the position-limiting portion extends into the position-limiting groove.

In an embodiment, an accommodating hole is defined in the mass block body and passes through the mass block body, the driving assembly includes a coil fixed in the housing, the vibration unit further includes a magnetic steel fixed in the accommodating hole and a magnetic conductive plate fixed on a side of the mass block body away from the coil, the magnetic steel is stacked and fixed on a side of the magnetic conductive plate close to the coil, and the coil is arranged opposite to the magnetic steel at an interval.

In an embodiment, an accommodating hole is defined in the mass block body and passes through the mass block body, the driving assembly is inserted into the accommodating hole, the driving assembly includes an iron core fixed to the housing and a coil wound around the iron core in the vibration direction of the vibration unit, the vibration unit further includes magnetic steels fixed in the accommodating hole, the magnetic steels are arranged opposite to the driving assembly at intervals, the magnetic steels include two first magnetic steels respectively arranged on two opposite sides of the driving assembly in the vibration direction of the vibration unit and two second magnetic steels respectively arranged on two opposite sides of the driving assembly in a direction perpendicular to the vibration direction of the vibration unit, and a magnetic conductive plate is sandwiched between each of the two second magnetic steels and the mass block body.

In an embodiment, an accommodating hole is defined in the mass block body and passes through the mass block body, the driving assembly is inserted into the accommodating hole, the driving assembly includes an iron core fixed to the housing and a coil wound around the iron core in the vibration direction of the vibration unit, the vibration unit further includes magnetic steels fixed in the accommodating hole, the magnetic steels are arranged opposite to the driving assembly at intervals, the magnetic steels include two third magnetic steels respectively arranged two opposite sides of the driving assembly in a direction perpendicular to the vibration direction of the vibration unit, and a magnetic conductive plate is sandwiched between each of the two third magnetic steels and the mass block body.

In an embodiment, an accommodating hole is defined in the mass block body and passes through the mass block body, the driving assembly is inserted into the accommodating hole, the driving assembly includes an iron core fixed to the housing and a coil wound around the iron core in the vibration direction of the vibration unit, the vibration unit further includes magnetic steels fixed in the accommodating hole, the magnetic steels are arranged opposite to the driving assembly at intervals, the magnetic steels include two fourth magnetic steels respectively arranged on two opposite sides of the driving assembly in a direction perpendicular to the vibration direction of the vibration unit, and a magnetic conductive member is sandwiched between a respective fourth magnetic steel of the two fourth magnetic steels and the mass block body, each magnetic member includes a flat plate portion sandwiched between the corresponding fourth magnetic steel and the mass block body, two bending portions extending from two opposite sides of the flat plate portion in the vibration direction of the vibration unit, and the respective fourth magnetic steel is arranged between the corresponding two bending portions.

Compared with the related art, the non-metallic elastic member of the vibration motor according to the embodiments of the present disclosure is made of a non-metallic material, which has the advantages as follows. The amplitude of the vibration unit is not limited, for example, when the amplitude of the vibration unit is greater than 1mm and the vibration unit is in the environment of 65% relative humidity and 95 degrees Celsius, the non-metallic elastic member still has good stability, the non-metallic elastic member does not limit the design thickness of the vibration motor, so that the vibration motor can be designed thinner. The non-metallic elastic member can be made by injection molding, and the shape is more designable and have more play space for design. For example, the non-metallic elastic member with complex shapes can be designed according to actual needs. The non-metallic elastic member can be directly connected with the vibration unit and the housing, so that the risk of welding failure of the metal elastic member is avoided, without using a welding pad to press the limit, so that the assembly process is simple and the cost is saved. The non-metallic elastic member also has damping function, which avoids the step of adding an additional damping to the vibration motor, reduces the risk of damping weakening of the additional damping under the environment of 65% relative humidity and 95 degrees Celsius, and stabilizes the stroke of the vibration motor in this environment, thus ensuring the service life of the vibration motor.

### BRIEF DESCRIPTION OF THE DRAWINGS

In order to explain the technical solution of the embodiments of the present disclosure more clearly, a brief introduction will be given to the accompanying drawings required for the description of the embodiments. Obviously, the drawings in the following description are only some embodiments of the present disclosure, and other drawings can be obtained according to these drawings without creative efforts.

FIG. 1 is a schematic perspective view of a first vibration motor provided in an embodiment of the present disclosure.

FIG. 2 is a schematic exploded view of the first vibration motor provided in the embodiment of the present disclosure.

FIG. 3 is a partially schematic exploded view of the first vibration motor provided in the embodiment of the present disclosure.

FIG. 4 is a cross-sectional view taken along line A-A in FIG. 1.

FIG. 5 is a partially schematic exploded view of a second vibration motor provided in an embodiment of the present disclosure.

FIG. 6 is a partially schematic exploded view of a third vibration motor provided in an embodiment of the present disclosure.

FIG. 7 is a schematic perspective view of a fourth vibration motor provided in an embodiment of the present disclosure.

FIG. 8 is a partially schematic exploded view of the fourth vibration motor provided in the embodiment of the present disclosure.

FIG. 9 is a cross-sectional view taken along line B-B in FIG. 7.

### Reference numerals are as follows:

100 vibration motor, 1 housing,

11 bottom plate, 12 side plate,

13 cover plate, 2 vibration unit,

21 magnetic steel, 21a first magnetic steel,

21b second magnetic steel, 21c third magnetic steel,

21d fourth magnetic steel, 22 mass block,

221 mass block body, 222 extending portion,

223 clamping portion, 2231 position-limiting groove,

23 magnetic conductive plate, 231 flat plate portion,

232 bending portion, 3 non-metallic elastic member,

31 first fixing arm, 32 second fixing arm,

321 position-limiting portion, 33 elastic arm,

4 driving assembly 41 iron core,

42 coil, 5 blocking sheet,

51 blocking sheet body, 52, connecting portion.

### DETAILED DESCRIPTION OF THE EMBODIMENTS

In the following, the technical solution in the embodiments of the present disclosure will be clearly and completely described with reference to the attached drawings. Obviously, the described embodiment is only a part of the embodiments of the present disclosure, not all the embodiments. Based on the embodiments in the present disclosure, all other embodiments obtained by those skilled in the art without creative efforts fall within the protection scope of the present disclosure.

### First embodiment

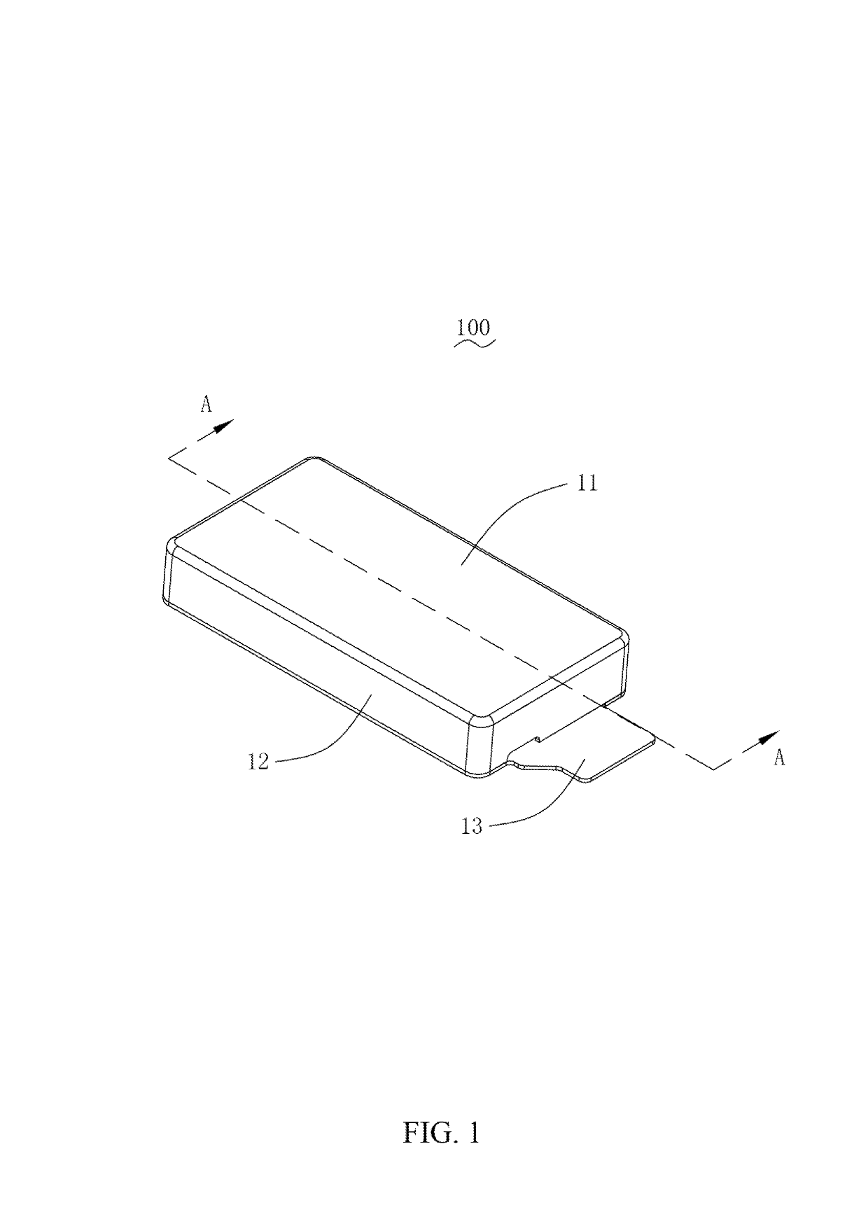

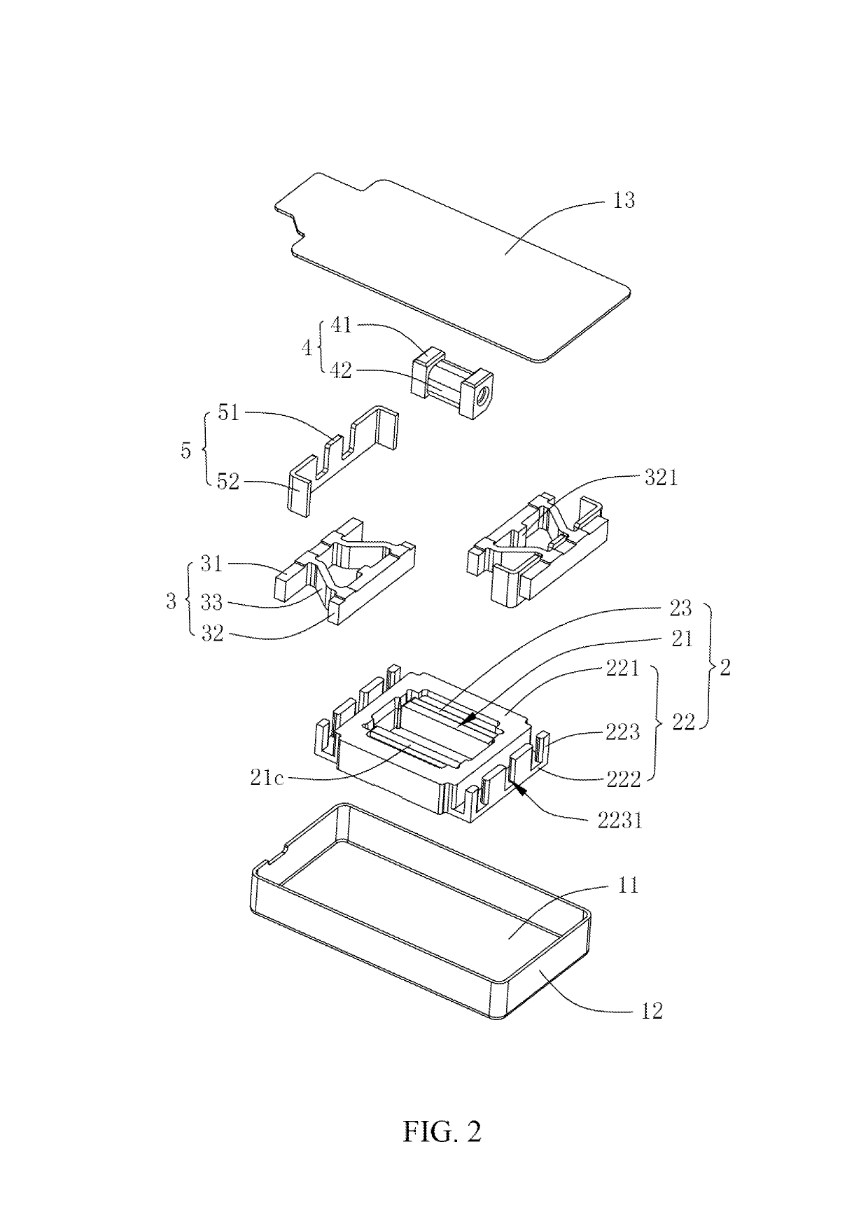

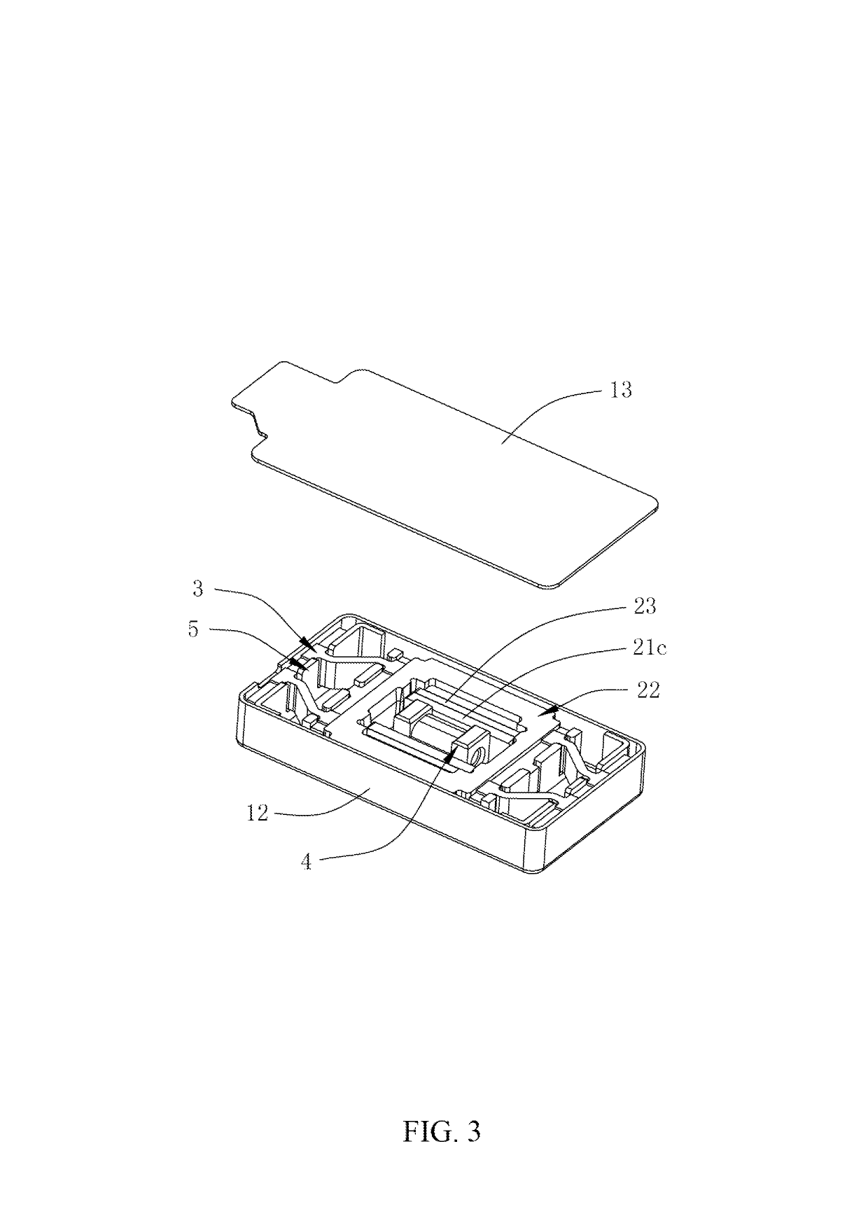

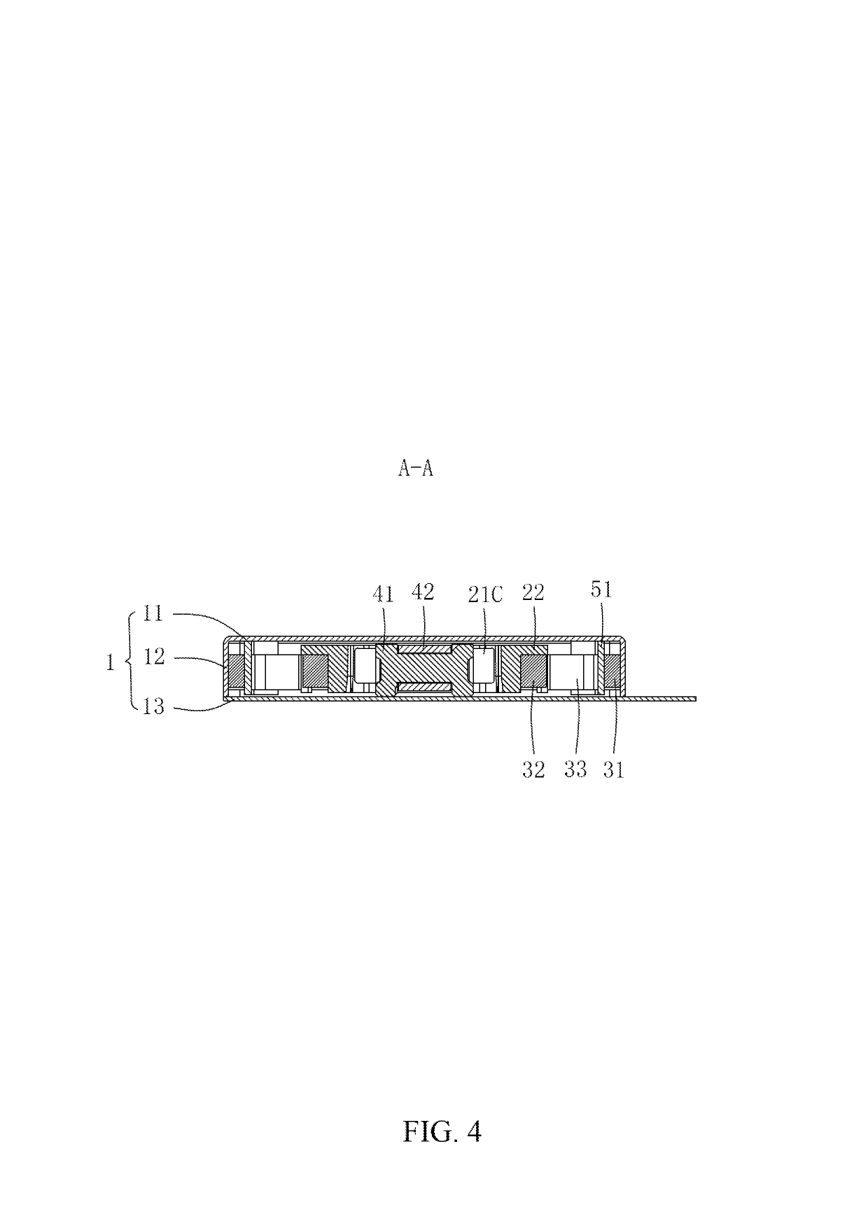

A vibration motor 100 is provided according to an embodiment of the present disclosure. Referring to FIG. 1 to FIG. 4, the vibration motor 100 includes a housing 1 with an accommodating space, a vibration unit 2 accommodated in the accommodating space 1, a non-metallic elastic member 3 fixed in the housing 1, and a driving assembly 4 accommodated in the housing 1 and configured to drive the vibration unit 2 to vibrate, and the non-metallic elastic member 3 is configured to elastically suspend the vibration unit 2 in the accommodating space.

The vibration motor 100 is rectangular, and correspondingly, the housing 1 and the vibration unit 2 are rectangular.

The housing 1 includes a bottom plate 11, a side plate 12 formed by bending and extending a peripheral side of the bottom plate 11, and a cover plate 13 covered on the side plate 12. An accommodating space is surrounded by the bottom plate 11, the side plate 12 and the cover plate 13. The non-metallic elastic member 3 is fixed to the side plate 12 and is spaced apart from the bottom plate 11 and the cover plate 13.

Specifically, the vibration unit 2 is one of a magnetic steel and a coil, and the driving assembly 4 is the other one of the magnetic steel and the coil. The vibration unit 2 is spaced apart from the driving assembly 4. The magnetic steel can be fixed directly or indirectly through an intermediate medium, and the coil can also be fixed directly or indirectly through an intermediate medium.

Specifically, the non-metallic elastic member 3 is any one of a silicone elastic member, a plastic elastic member, and a resin elastic member. Two non-metallic elastic members 3 are provided and are respectively arranged on two opposite sides of the vibration unit 2 in a vibration direction of the vibration unit 2. Each non-metallic elastic member 3 includes a first fixing arm 31 fixed to the housing 1, a second fixing arm fixed to the vibration unit 2, and an elastic arm 33 connecting the first fixing arm 31 with the second fixing arm 32. This design can better fix the non-metallic elastic member 3 to the housing 1 and the vibration unit 2, and increase the elasticity of the non-metallic elastic member 3.

The first fixing arm 31 is fixed to the side plate 12 of the housing. Each non-metallic elastic member 3 includes two elastic arms 33 arranged opposite to each other at an interval. This design can increase the stability of the elastic arms 33.

Specifically, the vibration motor 1 further includes two blocking sheets 5 fixed in the housing 1 at intervals, the two blocking sheets 5 are respectively arranged on two opposite side of the vibration unit 2, each blocking sheet 5 clamps and fixes the corresponding first fixing arm 31 to the housing 1, and each elastic arm 33 passes through the corresponding blocking sheet 5 and extends towards the second fixing arm 32. This design can limit the non-metallic elastic member 3 and avoid the risk of the non-metallic elastic member 3 falling off the housing 1.

The blocking sheets 51 are spaced apart from the bottom plate 11. Each blocking sheet 5 includes a blocking sheet body 51 spaced apart from the housing 1 and two connecting portion 52 formed by bending and extending two ends of the blocking sheet body 51, and the two connecting portions 52 are respectively fixed on two opposite sides of the housing 1. The blocking sheet body 51 of each blocking sheet 5 fixes the corresponding first fixing arm 31 to the housing 1. This design can increase the stability of the connection between the blocking sheets 5 and the housing 1, so as to better limit the non-metallic elastic member 3.

The two connecting portions 52 of each blocking sheet 5 are respectively fixed to two opposite sides of the side plate 12, that is, the blocking sheet body 51 of each blocking sheet 5 clamps and fixes the first fixing arm 31 of the corresponding non-metallic elastic member 3 to a side surface of the side plate 12.

Specifically, the mass block 22 includes a mass block body 221, extension portions 222 formed by extending from two opposite sides of the mass block body 221 in a direction away from the mass block body 221, and clamping portions 223 formed by bending and extending from one end of each respective extension portion 222 away from the mass block body 21, the clamping portions 223 are spaced apart from the mass block body 221, the second fixing arm 32 of each non-metallic elastic member 3 is clamped and fixed between the corresponding clamping portion 221 and the mass block body 221, and the elastic arm 33 passes through the corresponding clamping portion 223 to be connected with the second fixing arm 32. This design can limit the non-metallic elastic member 3 and avoid the risk of the non-metallic elastic piece 3 falling off the mass block 22.

A position-limiting groove 2231 is defined in the clamping portion 223 and passes through the respective clamping portion, one end of the second fixing arm 32 of each non-metallic elastic member 3 close to the first fixing arm 31 is provided with a position-limiting portion 321 extending toward the corresponding position-limiting groove 2231 of the clamping portion 223, and the position-limiting portion 321 extends into the position-limiting groove 2231. This design can better limit the non-metallic elastic member 3.

In this embodiment, the mass block 22 is rectangular, an accommodating hole is defined in the mass block body 221 and passes through the mass block body 221, and the driving assembly 4 is inserted in the accommodating hole. The driving assembly 4 includes a coil 41 fixed in the housing 1 and a coil 42 wound around the iron core 41 in the vibration direction of the vibration unit 2. The vibration unit 2 further includes magnetic steels 21 fixed in the accommodating hole, the magnetic steels 21 are arranged opposite to the driving assembly 4 at intervals, the magnetic steels 21 include two third magnetic steels 21c respectively arranged two opposite sides of the driving assembly 4 in a direction perpendicular to the vibration direction of the vibration unit 2, and a magnetic conductive plate 23 is sandwiched between each third magnetic steel 21c and the mass block body 221. The iron core 41 is fixed to the bottom plate 11 of the housing 1.

Compared with the related art, the non-metallic elastic member 3 of the vibration motor 100 according to the embodiments of the present disclosure is made of non-metallic materials, which has the advantages as follows. The amplitude of the vibration unit 2 is not limited, for example, when the amplitude of the vibration unit 2 is greater than 1mm and the vibration unit 2 is in an environment of 65% relative humidity and 95 degrees Celsius, the non-metallic elastic member 3 still has good stability. The non-metallic elastic member 3 does not limit the design thickness of the vibration motor 100, so that the vibration motor 100 can be designed thinner. The non-metallic elastic member 3 can be made by injection molding, and its shape is more designable and has more space to play. For example, the non-metallic elastic member 3 with complex shape can be designed according to actual needs. The non-metallic elastic member 3 can be directly connected with the vibration unit 2 and the housing 1, so that the risk of welding failure of the metal elastic member 3 is avoided, without using a welding pad to press the limit, so that the assembly process is simple and the cost is saved. The non-metallic elastic member 3 also has its own damping function, which avoids the step of adding an additional damping to the vibration motor 100, reduces the risk of damping weakening of the additional damping under the environment of 65% relative humidity and 95 degrees Celsius, and stabilizes the stroke of the vibration motor 100 in this environment, thus ensuring the service life of the vibration motor 100.

### Second embodiment

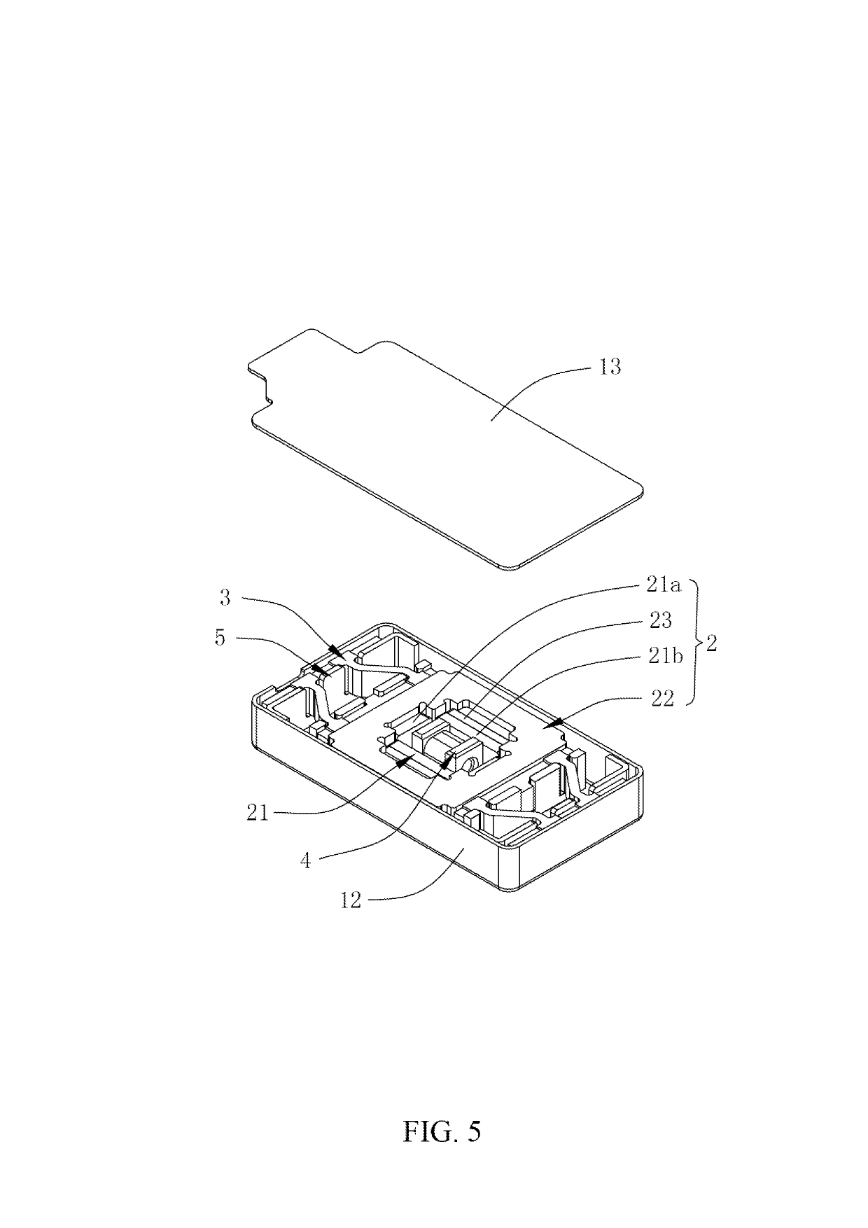

As shown in FIG. 5, different from the first embodiment, the magnetic steel 21 in this embodiment includes two first magnetic steels 21a respectively arranged two opposite sides of the driving assembly 4 in the vibration direction of the vibration unit 2, and two second magnetic steels 21b respectively arranged two opposite sides of the driving assembly 4 in a direction perpendicular to the vibration direction of the vibration unit 2, and a magnetic conductive plate 23 is sandwiched between each second magnetic steel 21b and the mass block body.

Meanwhile, grooves recessed inward are defined on an inner side of the mass body 221 at positions corresponding to the first magnetic steels 21a and the second magnetic steels 21b, and the first magnetic steels 21a and the second magnetic steels 22b are respectively fixed in the corresponding grooves.

### Third embodiment

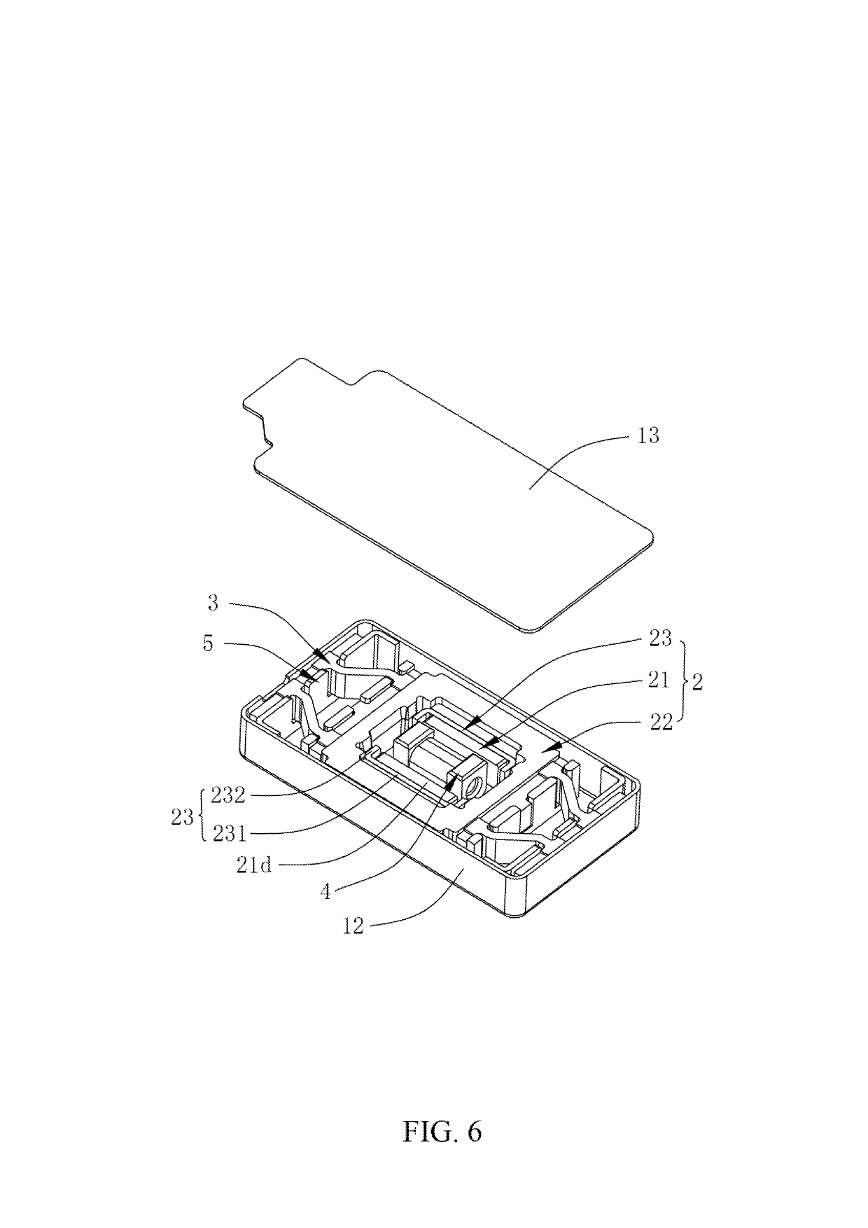

As shown in FIG. 6, different from the first embodiment, the magnetic steel 21 in this embodiment includes two fourth magnetic steels 21d respectively arranged two opposite sides of the driving assembly 4 in a direction perpendicular to the vibration direction of the vibration unit 2, and a magnetic conductive member 23 is sandwiched between each fourth magnetic steel 21d and the mass block body 221. Each magnetic member 23 includes a flat plate portion 231 sandwiched between the corresponding fourth magnetic steel 21d and the mass block body 221, and two bending portions 232 extending from two opposite sides of the flat plate portion 231 in the vibration direction of the vibration unit 2, and each fourth magnetic steel 21d is arranged between the corresponding two bending portions 232.

### Fourth embodiment

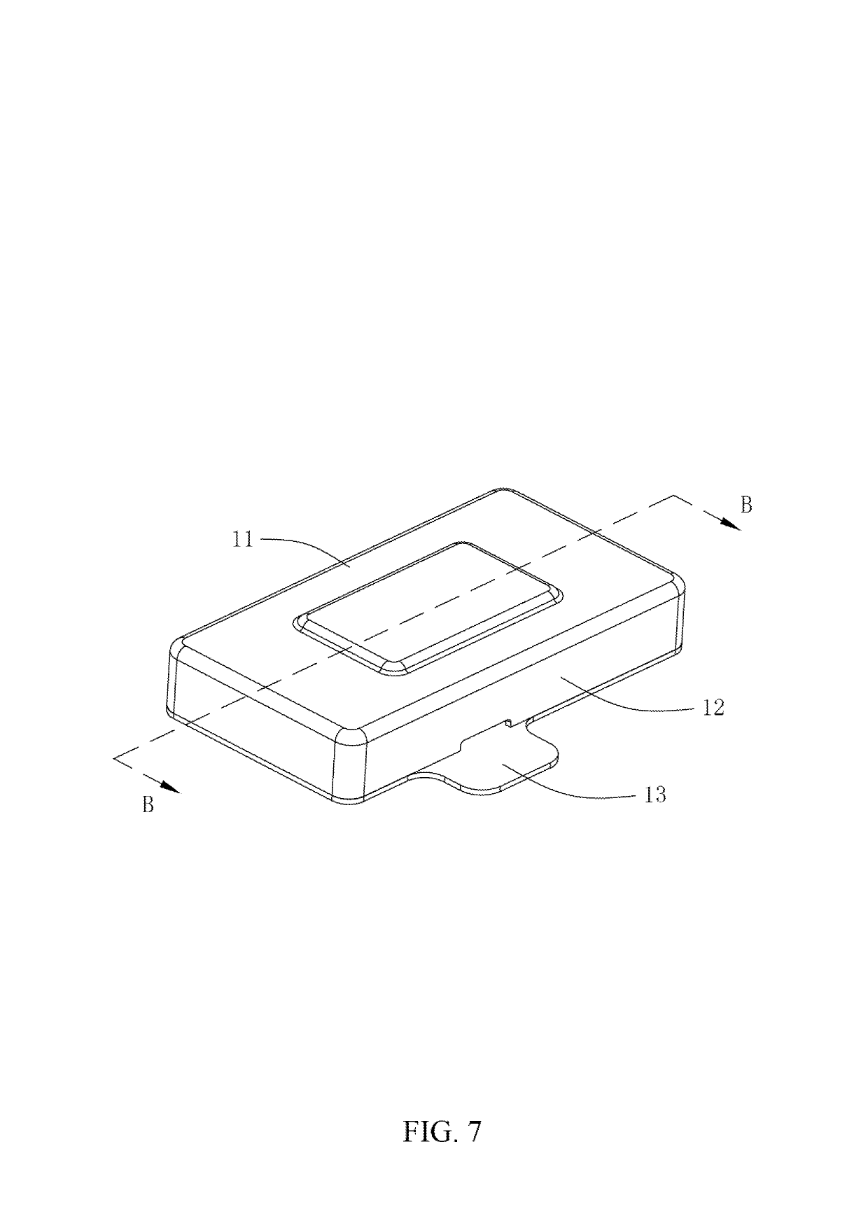

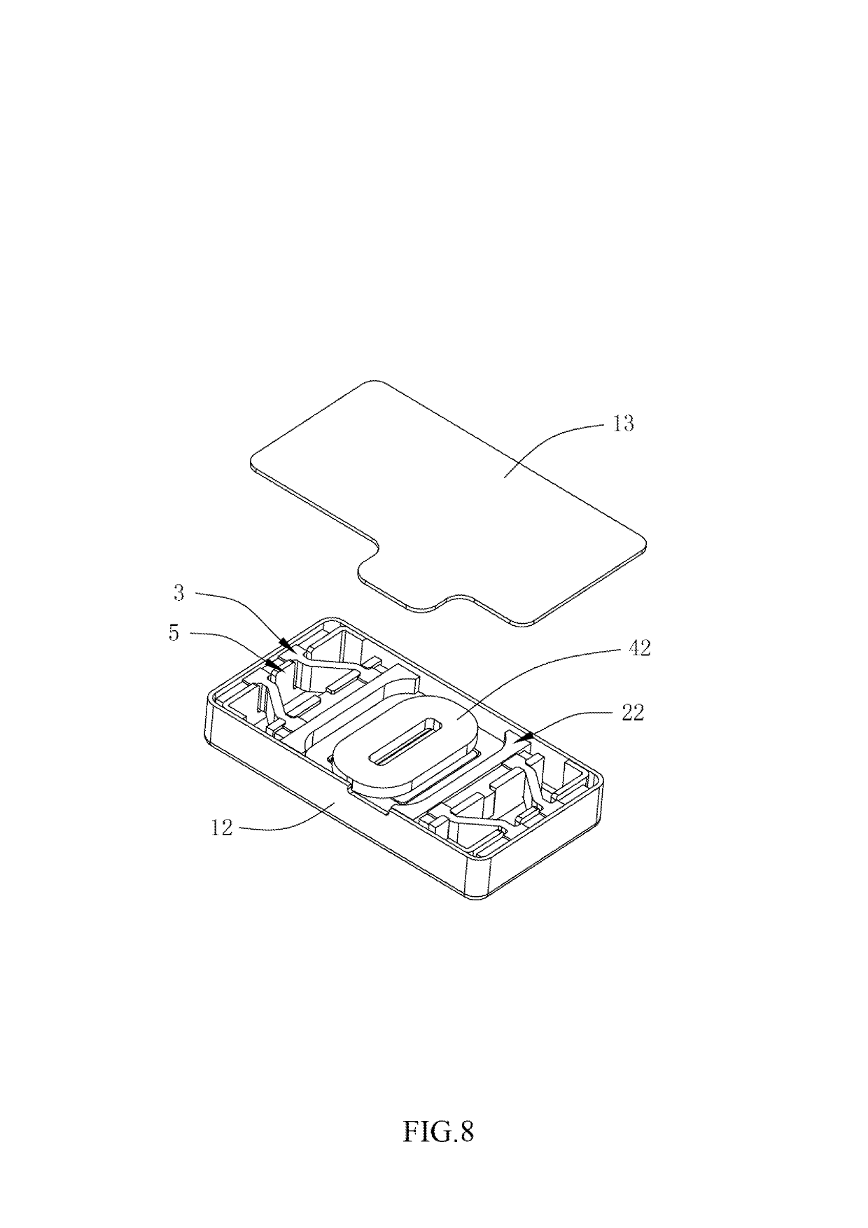

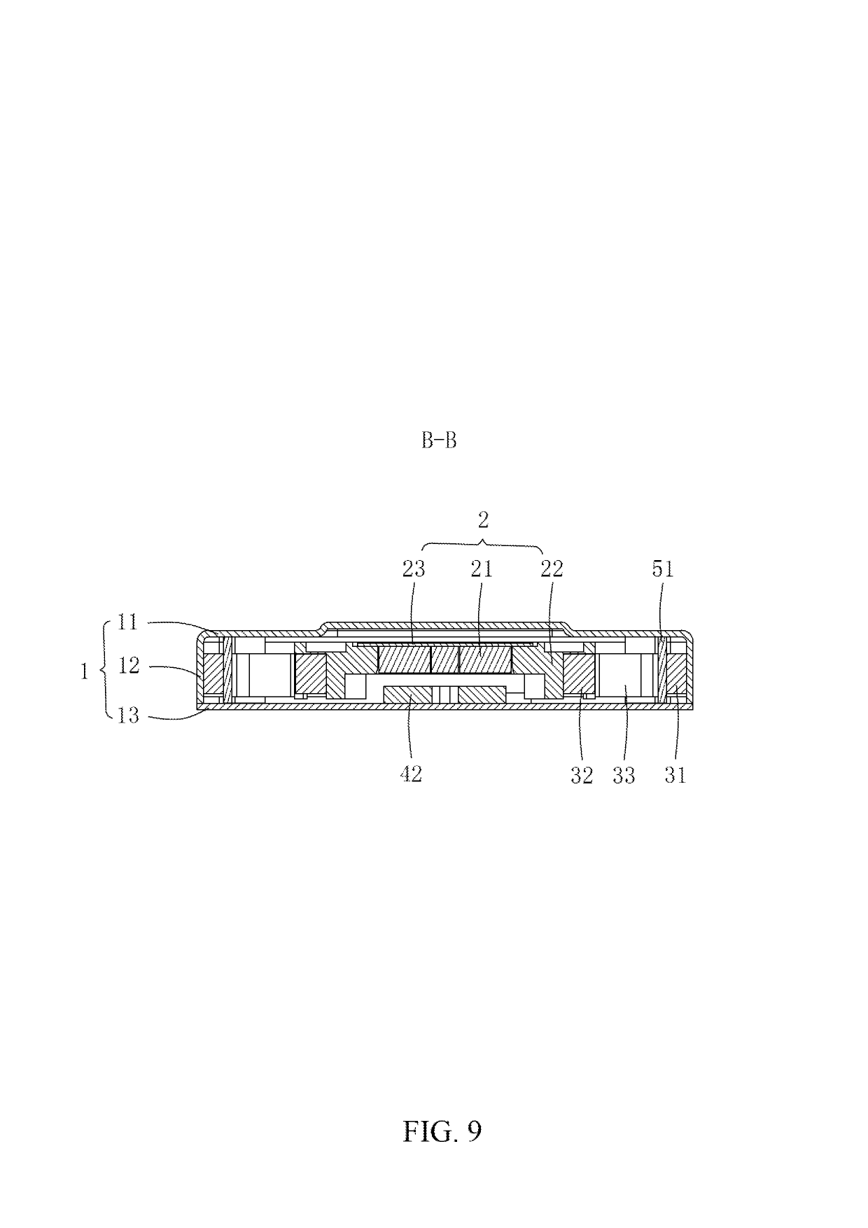

As shown in FIG. 7 to FIG. 9, different from the first embodiment, the driving assembly 4 in this embodiment is not provided with an iron core, and the coil 42 is directly fixed to the bottom plate 11 of the housing 1. The vibration unit 2 further includes a magnetic steel 21 fixed in the accommodating hole and a magnetic conductive plate 23 fixed on a side of the mass block body 221 away from the coil 42, the magnetic steel 21 is stacked and fixed on a side of the magnetic conductive plate 23 close to the coil 42, and the coil 42 is arranged opposite to the magnetic steel 21 at an interval.

In this embodiment, three magnetic steels 21 are provided, which are sequentially arranged from one side of the mass block body 221 to the opposite side.

The above are only the embodiments of the present disclosure. It should be pointed out that for those skilled in the art, improvements can be made without departing from the creative concept of the present disclosure, but these are all within the scope of protection of the present disclosure.

What is claimed is:

1. A vibration motor, comprising a housing with an accommodating space, a vibration unit accommodated in the accommodating space, a non-metallic elastic member fixed in the housing, and a driving assembly accommodated in the housing and configured to drive the vibration unit to vibrate, and the elastic member configured to elastically suspend the vibration unit in the accommodating space.

2. The vibration motor according to claim 1, wherein the non-metallic elastic member is any one of a silicone elastic member, a plastic elastic member, and a resin elastic member.

3. The vibration motor according to claim 1, wherein two non-metallic elastic members are provided and are respectively arranged on two opposite sides of the vibration unit in a vibration direction of the vibration unit, a respective non-metallic elastic member of the two non-metallic elastic members includes a first fixing arm fixed to the housing, a second fixing arm fixed to the vibration unit, and an elastic arm connecting the first fixing arm with the second fixing arm.

4. The vibration motor according to claim 3, wherein the vibration motor further comprises two blocking sheets fixed in the housing at an interval, the two blocking sheets are respectively arranged on two opposite side of the vibration unit, a respective blocking sheet of the two blocking sheets clamps and fixes the first fixing arm to the housing, and the elastic arm passes through the respective blocking sheet.

5. The vibration motor according to claim 4, wherein the respective blocking sheet comprises a blocking sheet body spaced apart from the housing, and two connecting portions formed by bending and extending two ends of the blocking sheet body, the two connecting portions are respectively fixed on two opposite sides of the housing, and the blocking sheet body of the respective blocking sheet fixes the first fixing arm to the housing.

6. The vibration motor according to claim 3, wherein the vibration unit further includes a mass block, the mass block includes a mass block body, extension portions formed by extending from two opposite sides of the mass block body in a direction away from the mass block body, and clamping portions formed by bending and extending from one end of each respective extension portion away from the mass block body, the clamping portions are spaced apart from the mass block body, the second fixing arm of the respective non-metallic elastic member is clamped and fixed between a respective clamping portion of the clamping portions and the mass block body, and the elastic arm passes through the respective clamping portion.

7. The vibration motor according to claim 6, wherein a position-limiting groove is defined in the respective clamping portion and passes through the respective clamping portion, one end of the second fixing arm of the respective non-metallic elastic member close to the first fixing arm is provided with a position-limiting portion extending toward the position-limiting groove of the respective clamping portion, and the position-limiting portion extends into the position-limiting groove.

8. The vibration motor according to claim 6, wherein an accommodating hole is defined in the mass block body and passes through the mass block body, the driving assembly includes a coil fixed in the housing, the vibration unit further includes a magnetic steel fixed in the accommodating hole and a magnetic conductive plate fixed on a side of the mass block body away from the coil, the magnetic steel is stacked and fixed on a side of the magnetic conductive plate close to the coil, and the coil is arranged opposite to the magnetic steel at an interval.

9. The vibration motor according to claim 6, wherein an accommodating hole is defined in the mass block body and passes through the mass block body, the driving assembly is inserted into the accommodating hole, the driving assembly includes an iron core fixed to the housing and a coil wound around the iron core in the vibration direction of the vibration unit, the vibration unit further includes magnetic steels fixed in the accommodating hole, the magnetic steels are arranged opposite to the driving assembly at intervals, the magnetic steels include two first magnetic steels respectively arranged two opposite sides of the driving assembly in the vibration direction of the vibration unit and two second magnetic steels respectively arranged two opposite sides of the driving assembly in a direction perpendicular to the vibration direction of the vibration unit, and a magnetic conductive plate is sandwiched between each of the two second magnetic steels and the mass block body.

10. The vibration motor according to claim 6, wherein an accommodating hole is defined in the mass block body and passes through the mass block body, the driving assembly is inserted into the accommodating hole, the driving assembly includes an iron core fixed to the housing and a coil wound around the iron core in the vibration direction of the vibration unit, the vibration unit further includes magnetic steels fixed in the accommodating hole, the magnetic steels are arranged opposite to the driving assembly at intervals, the magnetic steels include two third magnetic steels respectively arranged two opposite sides of the driving assembly in a direction perpendicular to the vibration direction of the vibration unit, and a magnetic conductive plate is sandwiched between each of the two third magnetic steels and the mass block body.

11. The vibration motor according to claim 6, wherein an accommodating hole is defined in the mass block body and passes through the mass block body, the driving assembly is inserted into the accommodating hole, the driving assembly comprises an iron core fixed to the housing and a coil wound around the iron core in the vibration direction of the vibration unit, the vibration unit further includes magnetic steels fixed in the accommodating hole, the magnetic steels are arranged opposite to the driving assembly at intervals, the magnetic steels include two fourth magnetic steels respectively arranged two opposite sides of the driving assembly in a direction perpendicular to the vibration direction of the vibration unit, a magnetic conductive member is sandwiched between a respective fourth magnetic steel of the two fourth magnetic steels and the mass block body, each magnetic member includes a flat plate portion sandwiched between the corresponding fourth magnetic steel and the mass block body, and two bending portions extending from two opposite sides of the flat plate portion in the vibration direction of the vibration unit, and the respective fourth magnetic steel is arranged between the corresponding two bending portions.
